(19) United States
(12) Patent Application Publication
(10) Pub. No.: US 2024/0326988 A1
(43) Pub. Date: Oct. 3, 2024

(54) SYSTEMS AND METHODS FOR ACTIVE CONTROL OF AIRCRAFT'S CENTER OF GRAVITY

(71) Applicant: PENTAXI LTD, Netanya (IL)

(72) Inventors: Eran GROSS, Netanya (IL); Yair DUBESTER, Kfar Saba (IL); Jacques CHEMLA, Shoham (IL)

(21) Appl. No.: 18/703,188

(22) PCT Filed: Oct. 9, 2022
(86) PCT No.: PCT/IB2022/059666

§ 371 Date: Apr. 19, 2024

Related U.S. Application Data
(60) Provisional application No. 63/257,132, filed on Oct. 19, 2021.

(51) Int. Cl. B64C 17/02; B64C 27/28; B64C 39/12; B64D 27/357; B64D 31/09; B64D 45/00; H01M 50/249

(52) U.S. Cl. CPC B64C 17/02; B64C 27/28; B64C 39/12; B64D 27/357; B64D 31/09; B64D 45/00; H01M 50/249; H01M 2220/20

(57) ABSTRACT

Systems and methods for an aircraft comprising: wings in tandem configuration wherein each wing having one tilting motor; an additional tilting motor located at the rear part of said aircraft; wherein all said tilting motors can tilt in the range between full horizontal and full vertical positions; at least two arrays of batteries, said arrays capable of moving forward and backward; sensing means; a computing device configured for: receiving said sensed information; controlling said motors; calculating the compensation required in case of a single motor failure and controlling the active motors accordingly; based on said sensed information and flight/movement instructions calculating continuously the optimal center of gravity location in the range possible given the movement range of said batteries arrays and controlling the movement of said batteries arrays accordingly.

### BACKGROUND

### 1. Technical Field

Embodiments of the present invention relate generally to systems and methods for active control of aircraft's center of gravity.

### 2. Description of Related Art

Current days development of air mobility crafts can be generally categorized to three families: 1. Vectored Thrust/Tiltrotors/Tilt-wings: Specific configuration in which the propulsion system is used for both Take-Off & Landing and for the horizontal flight. 2. Lift and Cruise: Configurations with a dedicated set of motors used only for the Take-Off & Landing phase and a Pusher/Puller motor for the horizontal flight. 3. Wingless/MultiCopters: Drone configuration with multiple fixed rotors/motors for both Take-Off & Landing and horizontal flight.

There are advantages and disadvantages for each of these configurations but in general the vectored thrust configurations are more efficient in cruise (longer ranges of operation) and the MultiCopters configurations are more efficient in the hover phase (better fitted for short distance operations). The lift and cruise configurations are a compromise between the MultiCopters and the Vectored thrust.

The Vectored thrust configurations are more complex in terms of flight safety mainly during the transition phases (from take-off to horizon flight and back to landing) and for the emergencies (mainly motor failure). That is the reason for the multiplication of motors in these configurations (usually between 6 to 36 motors!).

Hence, an improved systems and methods as described in this application are still a long felt need.

### BRIEF SUMMARY

According to an aspect of the present invention an aircraft comprising: wings in tandem configuration wherein each wing having one tilting motor; an additional tilting motor located at the rear part of said aircraft; wherein all said tilting motors can tilt in the range between full horizontal and full vertical positions; at least two arrays of batteries wherein one of said arrays is located in the lower front or middle of the aircraft and said second array is located in the lower rear part of said aircraft and wherein said arrays capable of moving forward and backward; sensing means adapted to sense at least: said tilting motors status and information; and said batteries arrays position, a non-transitory computer-readable medium storing processor executable instructions on a computing device, when executed by a processor, the processor executable instructions causing the processor to perform: receiving said sensed information; controlling said motors; calculating the compensation required in case of a single motor failure and controlling the active motors accordingly; based on said sensed information and flight/movement instructions calculating continuously the optimal center of gravity location in the range possible given the movement range of said batteries arrays and controlling the movement of said batteries arrays accordingly.

It is further within provision of the invention be wherein each of said rear wings is capable of forward sweep.

It is further within provision of the invention be wherein said batteries are connected using at least one main and at least one secondary power buses to create redundancy.

It is further within provision of the invention be wherein said front wings have shorter wingspan than said rear wings.

It is further within provision of the invention be wherein said tilting motors are arranged in pentagonal form 301 having the center of gravity located between said arrays of batteries.

It is further within provision of the invention be wherein said sensing means further adapted to sense the weight distribution of said aircraft.

It is further within provision of the invention be wherein in case of failure of one of said rear motors said calculations and controlling moves the center for gravity forward by moving at least one of said battery arrays forward.

It is further within provision of the invention be wherein in case of failure of one of said front motors said calculations and controlling moves the center for gravity backward by moving at least one of said battery arrays backward.

It is further within provision of the invention be wherein during liftoff, landing and transition phases said calculations and controlling moves the center for gravity by moving at least one of said battery arrays.

Another aspect of the present invention provides a method comprising: providing an aircraft having wings in tandem configuration wherein each wing having one tilting motor and an additional tilting motor located at the rear part of said aircraft, wherein all said tilting motors can tilt in the range between full horizontal and full vertical positions; providing, in said aircraft, at least two arrays of batteries wherein one of said arrays located in the lower front or middle of the aircraft and said second array is located in the lower rear part of said aircraft and wherein said arrays capable of moving forward and backward; providing, in said aircraft, sensing means adapted to sense at least: said tilting motors status and information; and said batteries arrays position, providing, in said aircraft, a non-transitory computer-readable medium storing processor executable instructions on a computing device, when executed by a processor, the processor executable instructions causing the processor to perform: receiving said sensed information; controlling said motors; calculating the compensation required in case of a single motor failure and controlling the active motors accordingly; based on said sensed information and flight/movement instructions calculating continuously the optimal center of gravity location in the range possible given the movement range of said batteries arrays and controlling the movement of said batteries arrays accordingly;

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1a illustrates the components of an embodiment of the present invention depicting tandem wing configuration;

FIG. 1b illustrates the components of an embodiment of the present invention depicting a forward sweep wings;

FIG. 1c illustrates the components of an embodiment of the present invention depicting control surfaces;

FIG. 2a illustrates the components of an embodiment of the present invention depicting possible movement of the arrays;

FIG. 2b illustrates the components of an embodiment of the present invention depicting possible positions of the arrays;

FIGS. 3a and 3b illustrates the components of an embodiment of the present invention depicting vertical tail configuration;

FIG. 4 illustrates the components of an embodiment of the present invention depicting pentagonal motor configuration;

FIG. 5a illustrates the components of an embodiment of the present invention depicting front wing motor in hover and horizontal flight position;

FIG. 5b illustrates the components of an embodiment of the present invention depicting rear wing motor in hover and horizontal flight position;

FIG. 5c illustrates the components of an embodiment of the present invention depicting rear motor in hover and horizontal flight position;

FIG. 6 illustrates the components of an embodiment of the present invention depicting lift control by propeller pitch and RPM of the five motors;

FIG. 7a illustrates the components of an embodiment of the present invention depicting Initial acceleration phase;

FIG. 7b illustrates the components of an embodiment of the present invention depicting second acceleration phase;

FIG. 7c illustrates the components of an embodiment of the present invention depicting final acceleration phase;

FIGS. 8a and 8b illustrates the components of an embodiment of the present invention depicting horizontal flight;

FIG. 9a illustrates the components of an embodiment of the present invention depicting active CG control for a failure in the rear motor;

FIG. 9b illustrates the components of an embodiment of the present invention depicting active CG control for a failure in the rear wing motor; and

FIG. 9c illustrates the components of an embodiment of the present invention depicting active CG control for a failure in the front wing motor.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for active control of aircraft's center of gravity.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing a tandem wing configuration having only five (5) tilting motors adapted to overcome a failure in any single motor without requiring emergency landing by controlling the center of gravity position and compensating using the remaining 4 operational motors.

Generally speaking, the system and method may allow in-flight repositioning of two batteries arrays by moving said arrays forward and backward. Such may also allow smooth transition between phases in the takeoff and landing which require changing from horizontal to vertical positions of the motors. In addition, the pentagonal configuration 401 may also contribute to such smooth transition between phases, as will be further explained.

In an embodiment of the invention, an aircraft 100 comprising wings 101-104 in tandem configuration wherein each wing may have one tilting motor 105-108 and may have an additional tilting motor 109 located at the rear part of the aircraft.

The five tilting motors may be capable of changing positions in the range between full horizontal 501 and full vertical 502 positions, as required for the operation of the aircraft.

The aircraft may have at least two arrays of batteries wherein one of the arrays 201 may be located in the lower front or middle of the aircraft and the second array 202 may be located in the lower rear part of the aircraft. Each of the arrays may be capable of moving forward and backward at any time as required for the operation of the aircraft.

The aircraft may further be equipped with sensing means adapted to sense any relevant information as known in the art as well as the tilting motors status, information and batteries arrays position and information regarding the center of gravity of the aircraft, weight distribution of and in the aircraft and each of the batteries arrays.

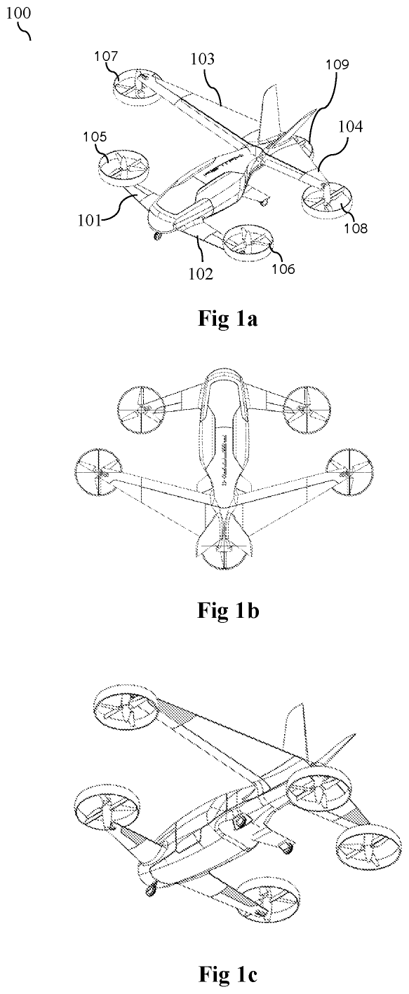

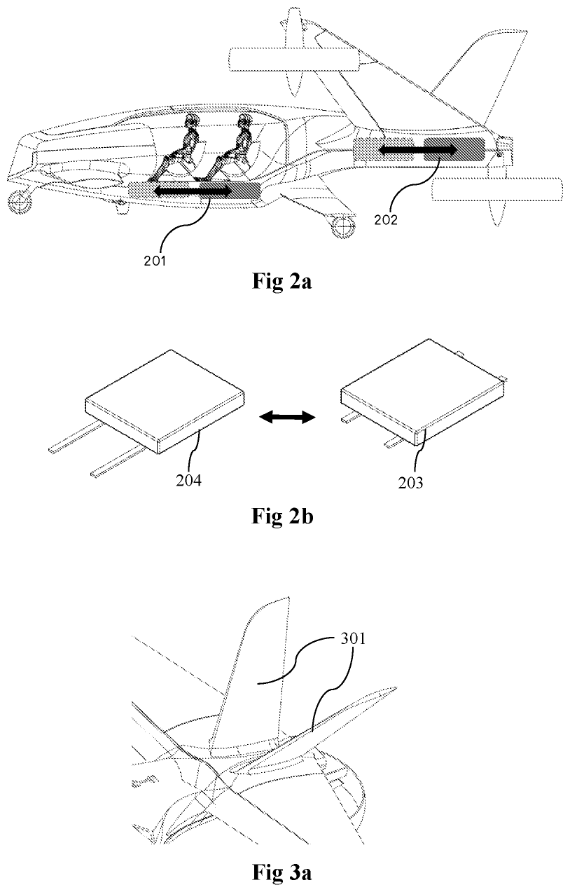

As depicted in FIGS. 1a-c and 2a, the aircraft may have a fuselage adapted to carry crew, passengers and/or cargo according to the internal configuration of the fuselage, as known in the art. In some embodiments of the invention, such may include human pilot or crew while in other embodiments of the invention the aircraft may be autonomous or remote controlled and hence pilot and crew will not be required. As can be further appreciated, doors may have opening mechanism to accommodate the fuselage design.

As specified above, the aircraft may have at least two arrays of batteries 201-202, in some embodiments of the invention, the first array may be located in the forward cabin (for example, below the passengers and may move forward 203 and backward 204 as required by the flight control system and the second array may be located in the rear part of the cabin and can also move forward and backward as required. Both arrays may be connected to a redundant power bus (one or more main power bus and one or more secondary power bus) providing the power to aircraft (for example to the electric motors, avionics, flight controls, and all the other aircraft systems).

As depicted in FIGS. 1a-c, 4, 6, 9a-c the wings may be in a tandem wing configuration. In some embodiments of the invention, the forward wings may have a shorter wingspan than the rear wings. each wing may have the tilting motor at their tip while the fifth tilting motors may be located at the rear part of the fuselage.

In further embodiments, the rear wings may have forward sweep to improve the stability margin by moving the neutral point forward. Both wings may have control surfaces at the wing tip to provide pitch and roll control during the horizontal flight.

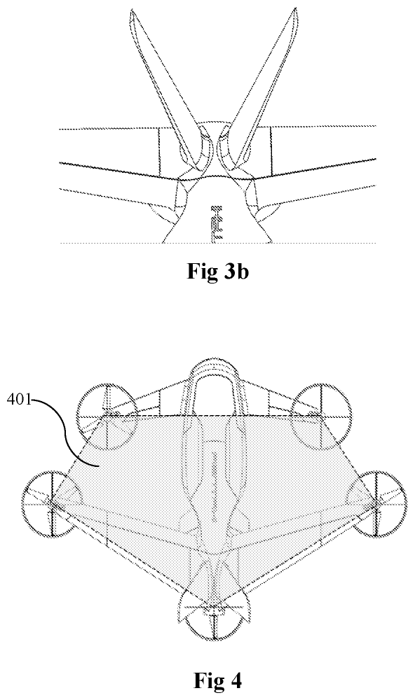

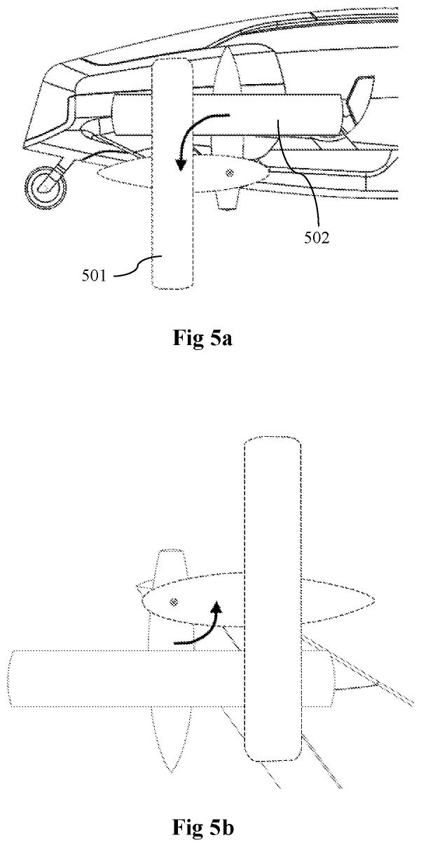

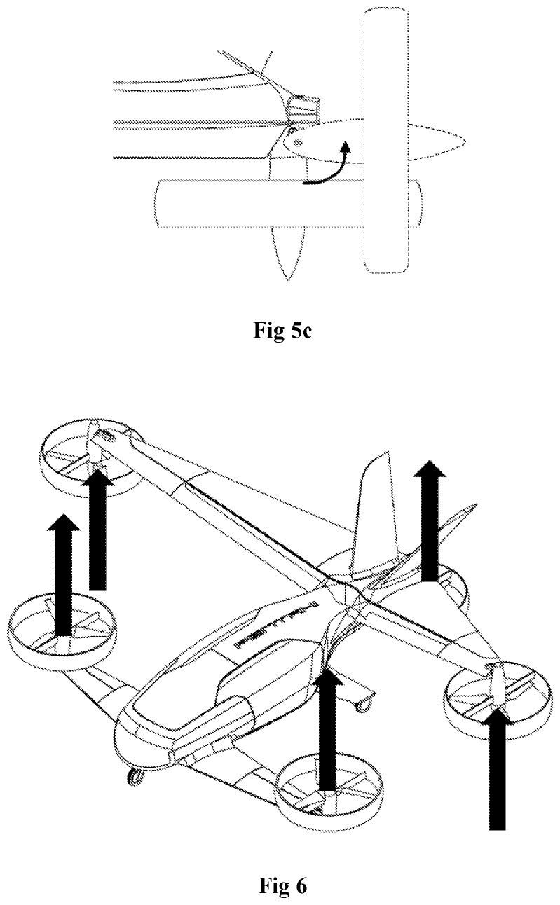

As depicted in FIG. 3 a vertical tail 301 may be located at the back of the fuselage just before the rear motor. Such configuration may improve lateral directional stability. In some embodiments, control surface may be not required since takeoff and landing phase are vertical.

In an embodiment of the invention, the tilting motors 105-109 may be located at the wing tips and at the rear part of the fuselage are creating a pentagon 401 with the center of gravity of the aircraft in the middle of it. The pentagonal motor configuration may provide a redundancy in case of a single motor failure even during the most critical phase (vertical flight).

In some embodiments of the invention, the forward motors (on the front wing) may rotate forward 120 degrees (−15 degrees from the vertical axis up to −15 degrees from the horizontal axis) on the leading edge. The backward motors (on the rear wing) may rotate backward 120 degrees (−15 degrees from the vertical axis up to −15 degrees from the horizontal axis) on the trailing edge. The fifth tilting motor on the back part of the fuselage may also rotate −15 degrees from the vertical axis up to −15 degrees from the horizontal axis.

A flight control system may be utilizing one of the aircraft's computing devices may have a non-transitory computer-readable medium storing processor executable instructions on the computing device, when executed by a processor may receive any relevant information and control any relevant systems and apparatuses in the aircraft, for example, control the tilting motors (rotating angle and thrust), the control surfaces (at least one at each wing tip) and the linear motors for the battery movement, etc.

The flight control system may further include triple redundancy for the computers and sensors and dual redundancy for the servo-actuators (five rotating motors, two linear motors for the CG control and four control surfaces). Adaptive control of the motors and the control surfaces may allow smooth transition between the different flight phases.

A specific example may be as follows. Pre-flight adjustments may be commenced after passengers finished boarding. The flight control system may then adjust the center of gravity to its nominal position by moving the front batteries and/or back accordingly.

During the take-off phase, as depicted in FIG. 6 the lift off may be done with optimal loading for all the motors (equal distance from the center of gravity). Pitch and altitude may be controlled by the motors thrust. The Roll attitude by differential thrust of the wing tips engines. The Yaw/Heading attitude (including the anti-torque due to the odd number of engines) may be controlled by differential activation of the wing tips motors angles, and the pitch attitude may be controlled by forward and backward motors thrust.

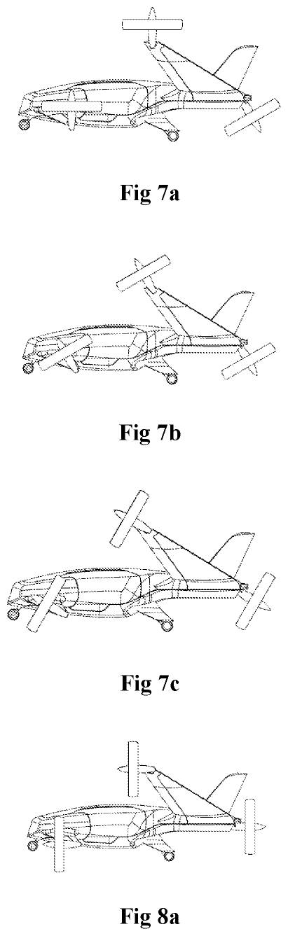

Transition from hover to flight, as depicted in FIG. 7a-c, may have the rear motor starts moving up to its acceleration position (30 degrees from the vertical) when the other motors are compensating the altitude and pitch (to remain with a stable pitch and constant positive rate of climb). The other four motors may start their movement forward as airspeed increases and lift coming from the wing is generated. The roll and pitch control may be progressively moving from the motors angles and thrust to the wing tips control surfaces.

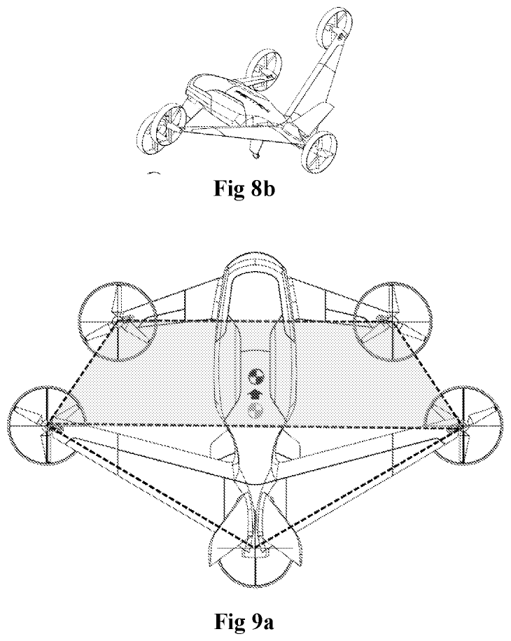

During the horizontal flight, as depicted in FIG. 8a-b, the motors may all be set to horizontal position. The rear pusher motor is generally the only one in use during the cruise (for optimization of the range performance). The activation of the four other motors (located at the wing tips) may be controlled by the flight control system that can operate them to increase the airspeed if necessary. The Pitch and roll attitude as well as the airspeed and altitude control may be done by the wing tips control surface and the engine power.

Transition from horizontal flight to hover is the most sensitive phase of the flight. The aircraft may reduce its airspeed smoothly when the wing tip motors are moving up to their vertical position. The flight control system may still control the aircraft with control surfaces and the rear motor provides negative thrust (by reverse thrust mechanism, by change of the propeller pitch), the four wingtip motors may compensate for the lift reduction (due to the airspeed reduction) to reduce the stall transient. When the air vehicle is stabilized at very low speed the rear motor may move to its vertical position to reduce the loading of the other motors. During this phase the center of gravity active control may be used to reduce the motors loading and optimize the vertical transient.

During landing, which is very similar in term of flight control to the take-off phase, when the rate of descent control and the precise landing position may be controlled by the motors thrust and angles (control surface are not effective). The center of gravity active control system may be used to optimize the motors loading.

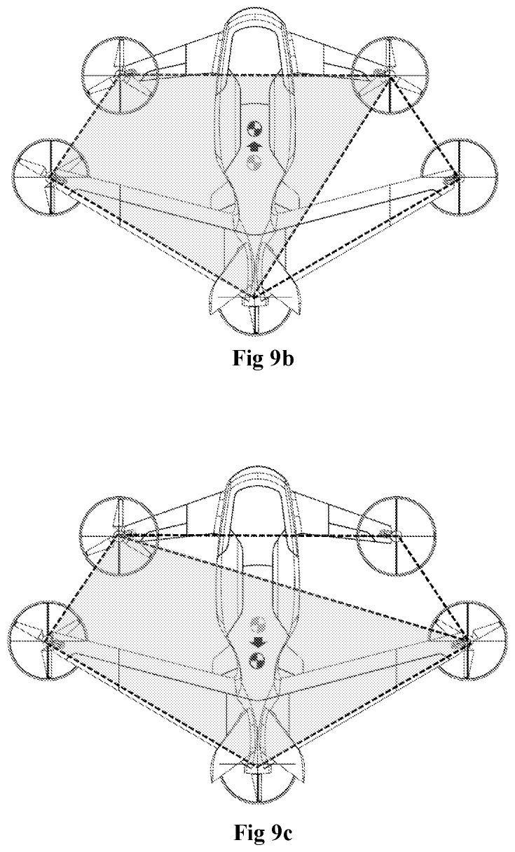

Emergencies i.e., a single motor failure, as depicted in FIGS. 9a-c, during horizontal flight may be deemed not critical for the aircraft disclosed in this invention since the aircraft is overpowered (one motor allows sustained flight). However, the critical phases explained are the hover phases during takeoff and landing as well as the transition phases.

The aircraft's active center of gravity control may be a software running on the aircraft's computing device, as mentioned above, may have the ability to received sensed information, calculate the compensation required in case of a single motor failure and controlling the aircraft's systems and apparatuses accordingly. Such may further, based on said sensed information and flight/movement instructions, calculate continuously the optimal center of gravity location in the range possible given the movement range of the batteries arrays and controlling the movement of the batteries arrays accordingly.

As depicted in FIGS. 9a and 9b, a rear motor failure and rear wing motor failure may be compensated and allow flight without emergency landing or crashing by allowing the active center of gravity control to move the center of gravity forward by moving at least one of the batteries arrays forward to reduce the wing motors loading.

As depicted in FIG. 9c, a front wing motor failure may be handled similarly however the center of gravity may be moved backward by moving at least one of the batteries arrays backward.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. An aircraft comprising:
wings in tandem configuration wherein each wing having one tilting motor;
an additional tilting motor located at the rear part of said aircraft;
wherein all said tilting motors can tilt in the range between at least full horizontal and full vertical positions;
at least two arrays of batteries wherein one of said arrays is located in the lower front or middle of the aircraft and said second array is located in the lower rear part of said aircraft and wherein said arrays capable of moving forward and backward;
sensing means adapted to sense at least:
said tilting motors status and information; and
said batteries arrays position,
a non-transitory computer-readable medium storing processor executable instructions on a computing device, when executed by a processor, the processor executable instructions causing the processor to perform:
receiving said sensed information;
controlling said motors and control surfaces;
calculating the compensation required in case of a single motor failure and controlling the active motors accordingly;
based on said sensed information and flight/movement instructions calculating continuously the optimal center of gravity location in the range possible given the movement range of said batteries arrays and controlling the movement of said batteries arrays accordingly.

2. The aircraft of claim 1 wherein each of said rear wings is having forward sweep.

3. The aircraft of claim 1 wherein said batteries are connected using at least one main and at least one secondary power buses to create redundancy.

4. The aircraft of claim 1 wherein said front wings have shorter wingspan than said rear wings.

5. The aircraft of claim 1 wherein said tilting motors are arranged in pentagonal form 301 having the center of gravity located between said arrays of batteries.

6. The aircraft of claim 1 wherein said sensing means further adapted to sense the weight distribution of said aircraft.

7. The aircraft of claim 1 wherein in case of failure of one of said rear motors said calculations and controlling moves the center for gravity forward by moving at least one of said battery arrays forward.

8. The aircraft of claim 1 wherein in case of failure of one of said front motors said calculations and controlling moves the center for gravity backward by moving at least one of said battery arrays backward.

9. The aircraft of claim 1 wherein during liftoff, landing and transition phases said calculations and controlling moves the center for gravity by moving at least one of said battery arrays.

10. A method comprising:
providing an aircraft having wings in tandem configuration wherein each wing having one tilting motor and an additional tilting motor located at the rear part of said aircraft, wherein all said tilting motors can tilt in the range between at least full horizontal and full vertical positions;
providing, in said aircraft, at least two arrays of batteries wherein one of said arrays located in the lower front or middle of the aircraft and said second array is located in the lower rear part of said aircraft and wherein said arrays capable of moving forward and backward;
providing, in said aircraft, sensing means adapted to sense at least:
said tilting motors status and information; and
said batteries arrays position,
providing, in said aircraft, a non-transitory computer-readable medium storing processor executable instructions on a computing device, when executed by a processor, the processor executable instructions causing the processor to perform:
receiving said sensed information;
controlling said motors and control surfaces;
calculating the compensation required in case of a single motor failure and controlling the active motors accordingly;
based on said sensed information and flight/movement instructions calculating continuously the optimal center of gravity location in the range possible given the movement range of said batteries arrays and controlling the movement of said batteries arrays accordingly;

11. The method of claim 10 wherein each of said rear wings having forward sweep.

12. The method of claim 10 wherein said batteries are connected using at least one main and at least one secondary power buses to create redundancy.

13. The method of claim 10 wherein said front wings have shorter wingspan than said rear wings.

14. The method of claim 10 wherein said tilting motors are arranged in pentagonal form 201 having the center of gravity located between said arrays of batteries.

15. The method of claim 10 wherein said sensing means further adapted to sense the weight distribution of said aircraft.

16. The method of claim 10 wherein in case of failure of one of said rear motors said calculations and controlling moves the center for gravity forward by moving at least one of said battery arrays forward.

17. The method of claim 10 wherein in case of failure of one of said front motors said calculations and controlling moves the center for gravity backward by moving at least one of said battery arrays backward.

18. The method of claim 10 wherein during liftoff, landing and transition phases said calculations and controlling moves the center for gravity by moving at least one of said battery arrays.
